(19) United States
(12) Patent Application Publication
(10) Pub. No.: US 2009/0310615 A1
(43) Pub. Date: Dec. 17, 2009

(54) Logical geographical and subscriber ONT subgroups in support of fiber-to-the-premises (FTTP) architecture

(75) Inventors: Marc R. Bernard, Miramar, FL (US); Douglas A. Atkinson, Ashburn, VA (US); Guy M. Merritt, Purcellville, VA (US); David H. Liu, Herndon, VA (US); Joseph D. Kralowetz, Clarksville, MD (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/157,770

(22) Filed: Jun. 13, 2008

(51) Int. Cl. H04L 12/56

(52) U.S. Cl. 370/401

(57) ABSTRACT

Example embodiments of the present invention help extend service provider visibility to all premises equipment (CPE) devices that are ranged with an Optical Line Terminal (OLT) by associating an Optical Network Terminal (ONT) within each device (CPE-ONT), such as a personal computer (PC), set-top box (STB), broadband home router (BHR), or analog telephone adapter (ATA). Therefore, each CPE device is managed independently via the CPE-ONT integrated with it. This allows each CPE device to terminate only optical signals supporting communications supported by the CPE device. Further, each CPE device has access to the entire GPON bandwidth, thereby increasing performance and eliminating bottlenecks caused by electrical communications over 10/100/1000 BaseT interfaces.

### BACKGROUND OF THE INVENTION

There are traditional networking products that provide limited throughput due to hardware limitations. For example, in a Passive Optical Network (PON), specifically a Gigabit PON (GPON) or Broadband PON (BPON) frequently used in Fiber-to-the-Premises (FTTP) networks, some Optical Network Terminal (ONT) products provide one Gigabit Media Independent Interface (GMII) interface from an Optical Line Terminal (OLT) to an on-board Ethernet switch or network processor. However, this produces bandwidth constraints between the OLT and each Customer Premises Equipment (CPE) device connected to the ONT that is requesting bandwidth. Although multiple ONTs may be provided at a single customer premises, only 2.5 gigabits per second (Gbps) of bandwidth can be provided per wavelength to each device which cannot be shared across multiple devices. Moreover, traditional methods of providing bandwidth throughout a premises, such as over coaxial cable (COAX) using the Multimedia over Coax Alliance (MoCA) standard and over twisted pair cable (TP) (e.g., Category 1 cable (CAT-1), Category 5 cable (CAT-5), and Category 6 cable (CAT-6)) by Ethernet, are limited in the bandwidth they can provide.

Further, an Element Management System (EMS) of the PON is generally not aware of the CPE devices in the network, such as in a home. Therefore, if there are problems with CPE devices, a service provider may not know if the problem is associated with the ONT or a device connected to the ONT. This can lead to added costs in sending a technician to the customer premises to diagnose the problem, which may turn out to be unnecessary, if the problem is, for example: a bad connection to a CPE device, a home router that is not connected or functioning properly, or another problem with a CPE device limited to customer equipment.

### SUMMARY OF THE INVENTION

A method or corresponding apparatus in an example embodiment of the present invention manages network nodes in a communications network that has an upstream node, such as an Optical Line Terminal (OLT), and downstream nodes, such as Optical Network Terminals (ONTs), also referred to herein as Customer Premises Equipment (CPE) ONTs (CPE-ONTs). In an example embodiment, the method or corresponding apparatus includes CPE-ONT network nodes that may be managed by allocating timeslots for upstream communications for use by the downstream CPE-ONT nodes based on timeslots assigned by the upstream node, such as the OLT, in the communications network. The downstream CPE-ONT nodes then may be monitored for a change of their state. Based on this change of state of a downstream CPE-ONT node configured to communicate in an upstream direction with the OLT or an Element Management System (EMS), timeslots for communicating upstream of the downstream CPE-ONT nodes are reallocated.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-1B are a flow diagram and a block diagram, respectively, illustrating example embodiments of the present invention.

FIG. 2 is a block diagram of an example network employing example embodiments of the present invention.

FIG. 2-1 is a diagram of a prior art customer premises of the example network of FIG. 2 employing an optical-to-electrical architecture.

FIGS. 2-2-2-4 are diagrams of example customer premises of the example network of FIG. 2 employing example embodiment optical architectures of the present invention.

FIGS. 3A-3C are diagrams illustrating logical subgroups that may be defined according to example embodiments of the present invention.

FIGS. 4A-4D illustrate methods by which subgroups may be defined.

FIG. 5 is a flow diagram illustrating a method of configuring a logical subgroup.

FIG. 6 is a flow diagram illustrating logical subgroup ranging/discovery.

FIG. 7 is a flow diagram illustrating an example method employed following detection of notifications/events in the network.

FIG. 8 is a diagram illustrating the flow of information and payment for network/event information.

### DETAILED DESCRIPTION OF THE INVENTION

A description of example embodiments of the invention follows.

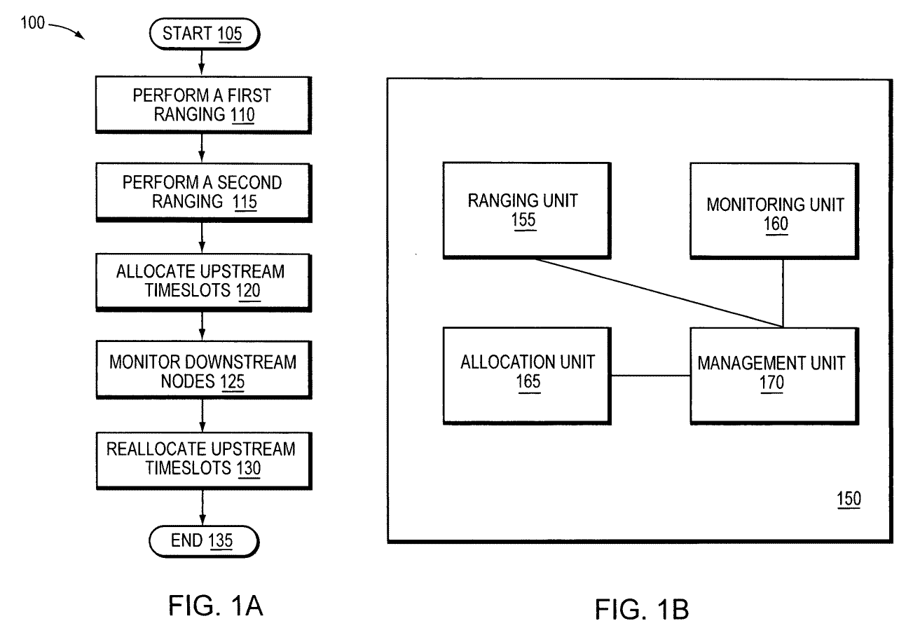

FIG. 1A is a flow diagram 100 illustrating an example embodiment method of the present invention for managing network nodes in a communications network. First, after the method commences (105), a first ranging (110) and a second ranging (115) are performed. Upstream timeslots are allocated (120) to downstream nodes based on timeslots assigned by an upstream node in the communications network. The downstream nodes are monitored (125) for a change of state, which may be a change of nodes or change of upstream communications. Based on results of at least one of the first ranging and the second ranging and a change of state of downstream nodes configured to communication in an upstream direction, upstream timeslots of the downstream nodes are reallocated (130). The method then ends (135).

FIG. 1B is a block diagram illustrating an example embodiment apparatus of the present invention for managing network nodes in a communications network. The apparatus 150 includes a ranging unit 155 to conduct a first physical layer ranging with an upstream node and a second physical layer ranging with downstream nodes, and a monitoring unit 160 to monitor the downstream nodes for a change of state of the downstream nodes. The apparatus further includes an allocation unit 165 to allocate upstream timeslots to downstream nodes based on timeslots assigned by the upstream node. A management unit 170 is also included to instruct the allocation unit 165 to reallocate upstream timeslots of the downstream nodes based on results of the first physical layer ranging and the second physical layer ranging and a change of state of downstream nodes configured to communicate in an upstream direction.

The reallocation of timeslots may be based on a number of downstream nodes or characteristics of communications of the downstream nodes. Such characteristics may include one or more of: latency, packet size, packet rates, jitter, packet header information, or information discovered from the downstream nodes.

Allocating upstream timeslots to downstream nodes further may be based on presence of other communications services supporting upstream communications to the upstream node. Further, allocating and reallocating upstream timeslots to downstream nodes further may be based on priority of services supporting upstream communications to the upstream node. Moreover, upstream timeslots configured to communication in the upstream direction allocated to the downstream nodes may be renegotiated with the upstream node.

Subgroups to which the downstream nodes are assigned also may determine the allocating and reallocating of upstream timeslots to downstream nodes. Further, such allocating and reallocating also may be based on modifying a grant map by the upstream node and may further include adjusting the grant map based on a change of state of the downstream node for use in future reallocating of the upstream timeslots. Moreover, the allocating and reallocating may be performed by the upstream node. Reallocating may be performed independent of the upstream node.

The communications network may be a point-to-multipoint network, such as a Multimedia over Coax Alliance (MoCA) network or a PON. The PON may further include an OSC to split and combine communications downstream of the upstream node and upstream of at least one of the downstream nodes, with at least one of the allocating, monitoring and reallocating being performed at an intermediate node downstream of the OSC and upstream of at least one of the downstream nodes. Another OSC may split and combine communications downstream of the intermediate node and upstream of at least one of the downstream nodes. Communications in the communications network may include communication with nodes in an electrical or wireless network other than the PON.

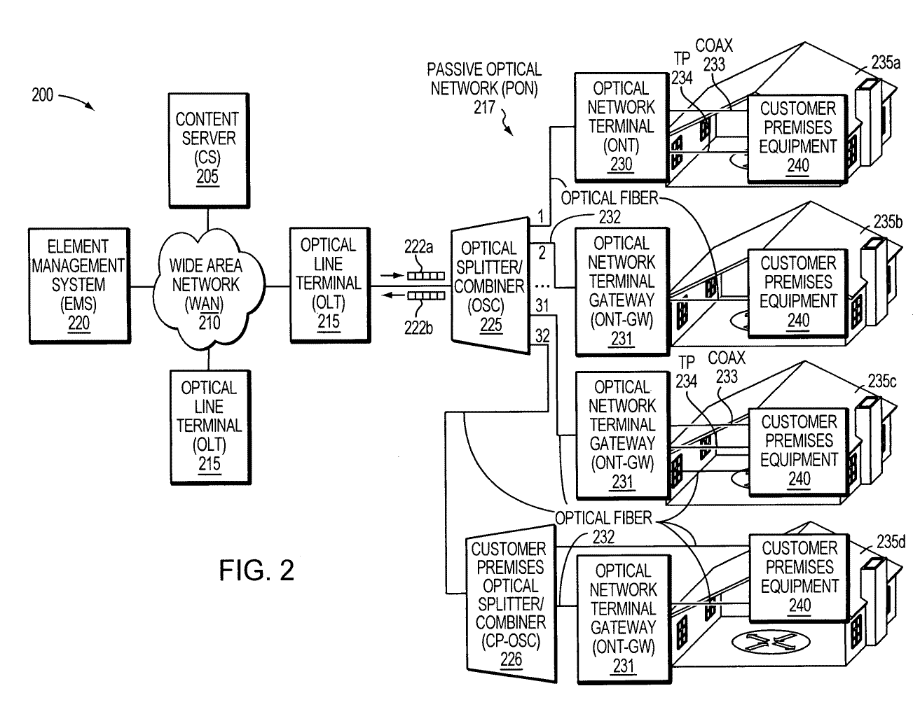

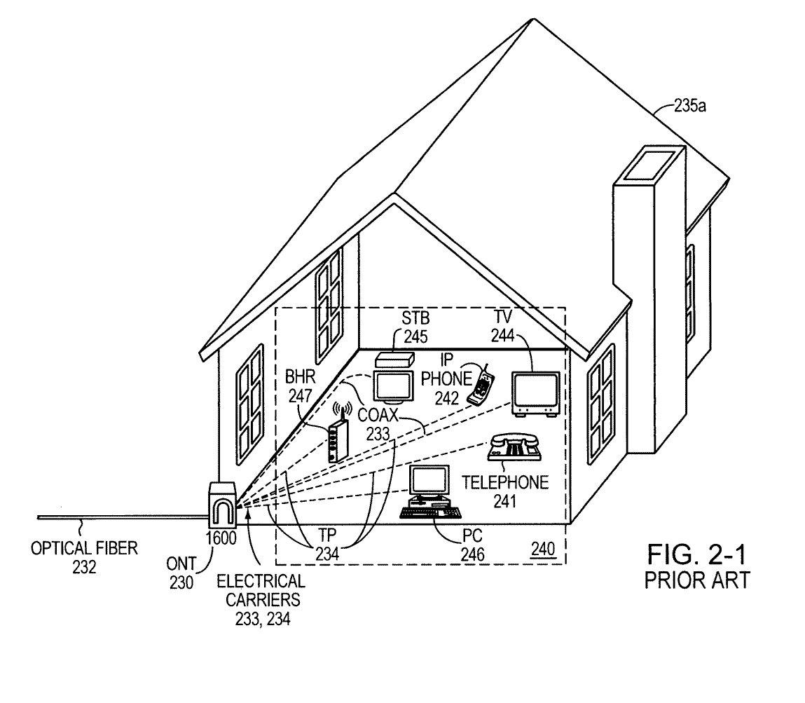

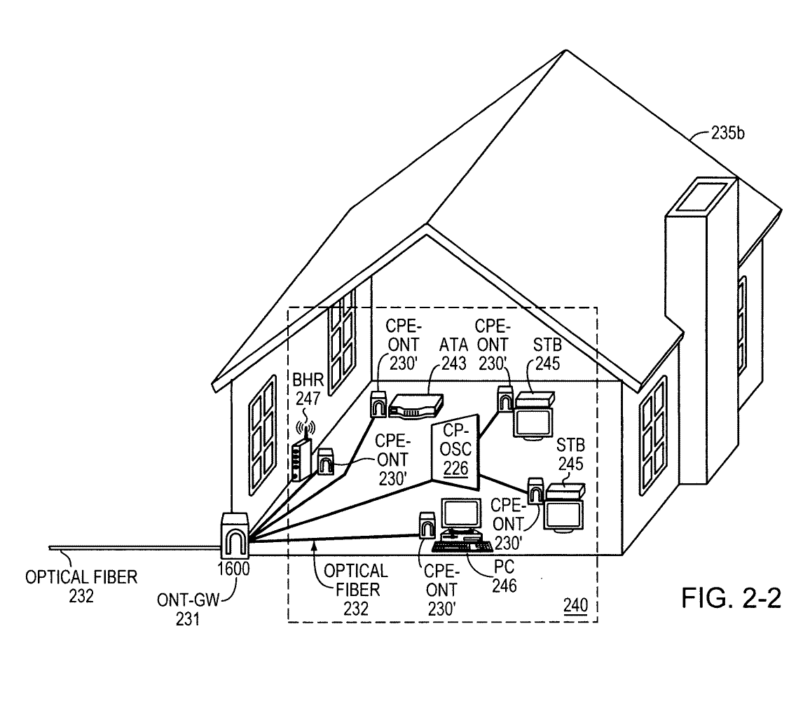

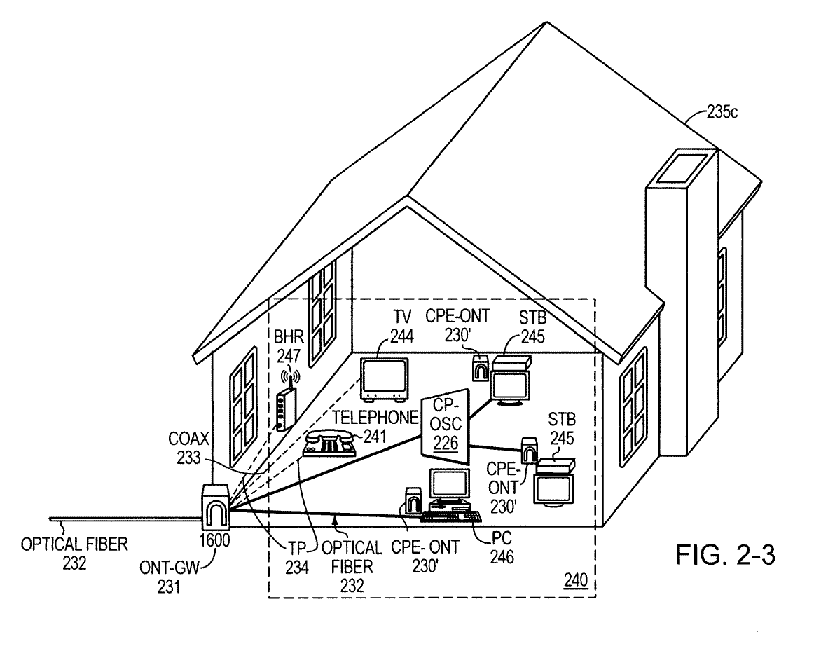

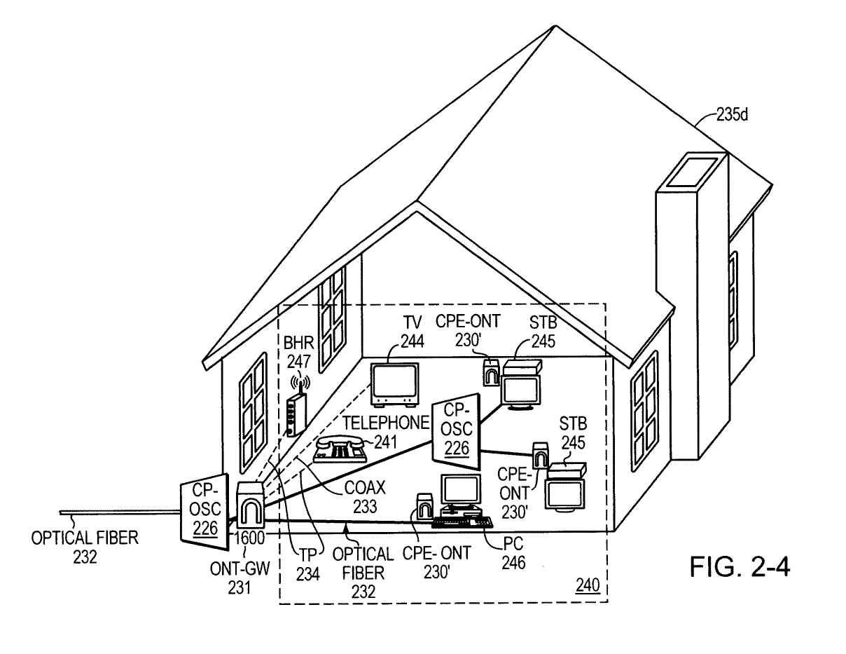

FIG. 2 is a block diagram of an example network 200 in which example embodiments of the present invention may be employed. The network 200 includes a Wide Area Network (WAN) 210 and a Passive Optical Network (PON) 217. The WAN 210 may be a network such as the Internet, and the PON 217 is typically a more localized network in which optical signals, used to transmit information, traverse passive optical elements, such as splitters and combiners, to be communicated between network nodes.

The example network 200 includes one or more Optical Line Terminals (OLTs) 215, an Element Management System (EMS) 220, and a Content Server (CS) 205, all connected, generally, by the WAN 210. In the example network 200, each OLT 215 transmits/receives information in the form of a frame of packets 222a, 222b embodied on optical signals to/from an optical splitter/combiner (OSC) 225 to communicate with, for example, thirty-two Optical Network Terminals (ONTs) 230, ONT Gateways (ONT-GWs) 231, or customer premises OSCs (CP-OSCs) 226. The ONTs 230, ONT-GWs 231 and CP-OSCs 226 provide connectivity to customer premises equipment (CPE) devices 240 that may include standard telephones (e.g., Public Switched Telephone Network (PSTN) and cellular network equipment), Internet Protocol (IP) telephones, analog telephone adapters (ATAs), video devices (e.g., analog televisions (TVs) and digital cable decoders/set-top boxes (STBs)), computer terminals/personal computers (PCs), Broadband Home Routers (BHRs) (wired or wireless), digital subscriber line (DSL) connections, cable modems, wireless access devices, as well as any other conventional, newly developed, or later developed devices that may be supported by the ONTs 230, ONT-GWs 231 or CP-OSCs 226.

FIG. 2 illustrates four example customer premises 235a-235d, described below in greater detail with reference to FIGS. 2A-2D, respectively, included in the PON 217. The first example customer premises 235a includes an optical-to-electrical architecture, with an ONT 230 terminating optical signals and managing all services in the customer premises via traditional electrical carriers, such as COAX 233 and TP 234. However, in the other customer premises 235b-235d, in example embodiments of the present invention the OLT 215 and/or EMS 220 manages ONTs at CPE devices (CPE-ONTs) 230′ via optical fiber 232.

FIG. 2-1 is a diagram illustrating a customer premises 235a as in the prior art (e.g., customer premises 235a of FIG. 2) having a prior art traditional ONT 230 and downstream CPE devices 240, such as a telephone 241, IP telephone 242, TV 244, STB 245 and BHR 247. The ONT 230 terminates optical communications over optical fiber 232 and supports communications downstream of the ONT 230 transmitted via electrical carriers, such as COAX 233 and TP 234. For example, communications downstream of the ONT 230 to the television 244 and STB 245 are carried electrically over COAX 233. Further, communications downstream of the ONT 230 to the telephone 241, IP telephone 242, PC 246 and BHR 247 are carried electrically over twisted pair (TP) wires 234.

FIG. 2-2 is a diagram illustrating a customer premises 235b (e.g., customer premises 235b of FIG. 2) comprising an ONT Gateway (ONT-GW) 231 connected by optical fiber 232 with CPE-ONTs 230′ at each downstream CPE device 240, some of which may be supported by a CP-OSC 226, with optical communications over optical fiber 232 terminated at each respective CPE-ONT 230′. The ONT-GW 231 has integrated User-to-Network Interface-(UNI) Side OLT functions to support communications with the CPE devices 240 via their respective CPE-ONTs 230′. Thus, the ONT-GW 231 supports optical communications over optical fiber 232 with downstream CPE-ONTs 230′ at each CPE device 240, such as an Analog Telephone Adapter (ATA) 243, STB 245, PC 246, and BHR 247.

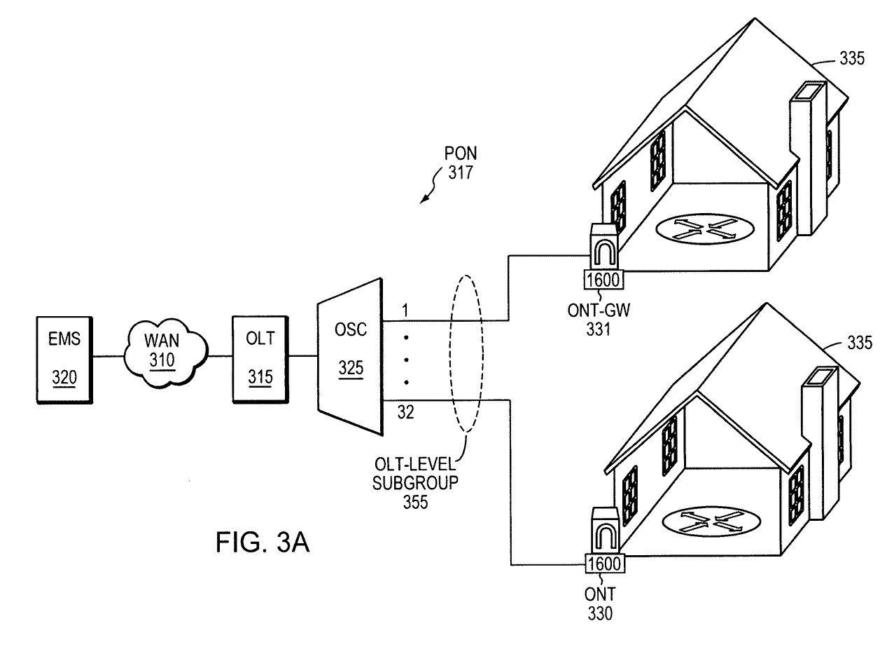

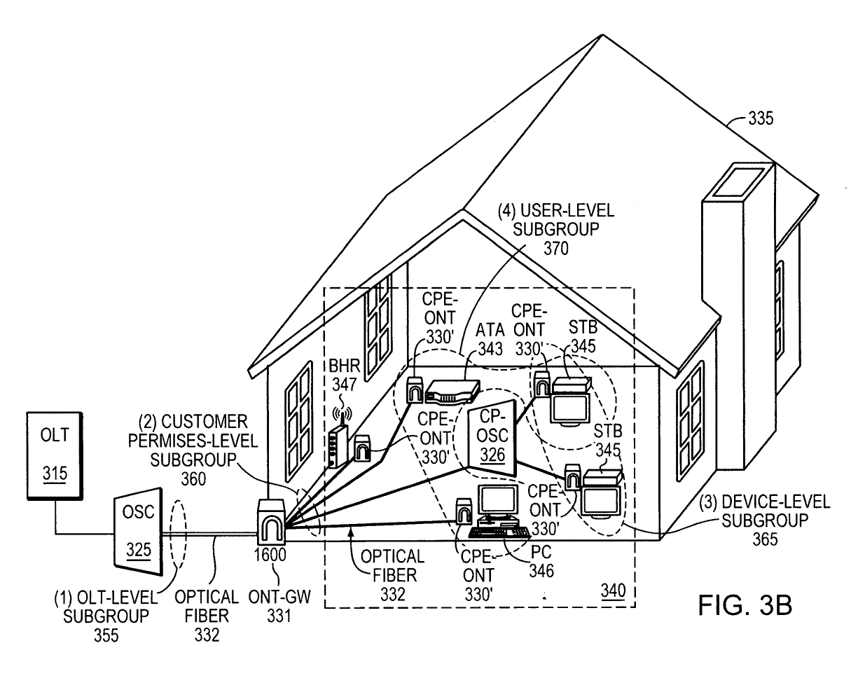

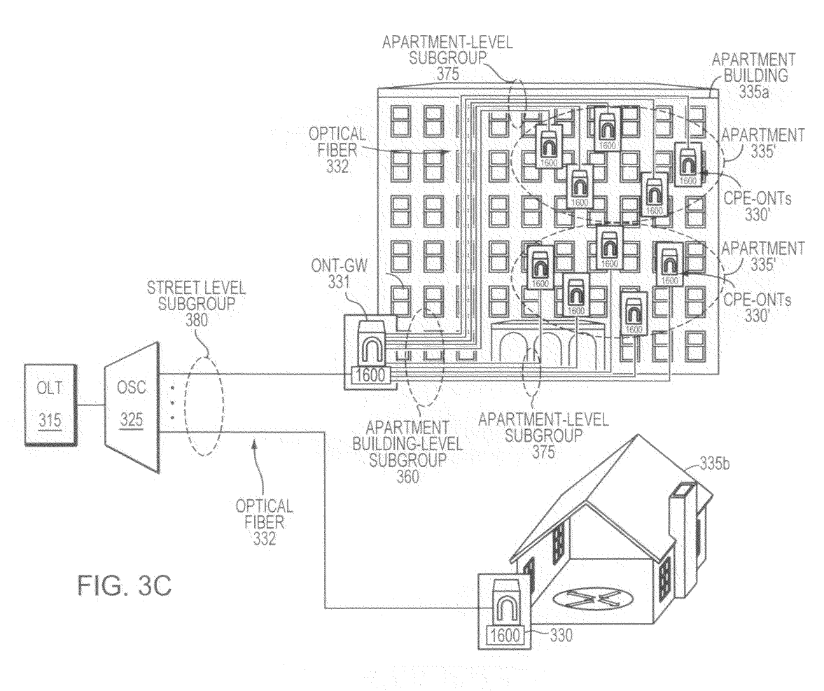

FIG. 2-3 is a diagram illustrating a customer premises 235c (e.g., customer premises 235c of FIG. 2), which combines the optical-to-electrical architecture of the first customer premises 235a of FIG. 2 and the optical architecture of the customer premises 235b of FIG. 2-2, with an ONT-GW 231 connected by optical fiber 232 with CPE-ONTs 230′ at certain downstream CPE devices 240, some of which may be supported by a Customer Premises Optical Splitter Combiner (CP-OSC) 226, with optical communications over optical fiber 232 terminated at each respective CPE-ONT 230′. The ONT-GW 231 has integrated UNI-Side OLT functions to support communications with CPE devices 240 via their respective CPE-ONTs 230′. Further, the ONT-GW 231 terminates other certain optical communications over optical fiber 232 and provides connectivity to other certain downstream CPE devices 240 via electrical carriers, such as COAX 233 and TP 234. Thus, the ONT-GW 231 supports a mixed behavior and provides an abstraction layer between the CPE-ONT 230′ and the service provider's management system (e.g., EMS 220 of FIG. 2). The ONT-GW 231 supports optical communications over optical fiber 232 with downstream CPE-ONTs' 230′ at each certain CPE device 240, such as STBs 245 and a PC 246, and electrical communications with other certain downstream CPE devices 240, such as a TV 244 over COAX 233 and a telephone 241 and a BHR 247 over TP 234.

FIG. 2-4 is a diagram illustrating a customer premises 235d (e.g., customer premises 235d of FIG. 2) with a CP-OSC 226 at the exterior of the customer premises 235d connected directly by optical fiber 232 with CPE-ONTs 230′ at CPE devices 240 and with an ONT-GW 231, as described above with reference to the customer premises 235c of FIG. 2-3. The ONT-GW 231 is connected by optical fiber 232 with CPE-ONTs 230′ at certain downstream CPE devices 240, some of which may be supported by a CP-OSC 226, with optical communications over optical fiber 232 terminated at each respective CPE-ONT 230′. The CP-OSC 226 at the exterior of the customer premises 235d supports direct optical communications over optical fiber 232 between the OLT 215 and the CPE-ONTs 230′ at an STB 245 and a PC 246. The ONT-GW 231 has integrated UNI-Side OLT functions to support communications with CPE devices 240 via their respective CPE-ONTs 230′. Further, the ONT-GW 231 terminates other certain optical communications over optical fiber 232 and provides connectivity to other certain downstream CPE devices 240 via electrical carriers, such as COAX 233 and TP 234. Thus, the ONT-GW 231 supports a mixed behavior and provides an abstraction layer between the CPE-ONTs 230′ and the service provider's management system (e.g., EMS 220 of FIG. 2). The ONT-GW 231 supports optical communications over optical fiber 232 with certain downstream CPE-ONTs 230′ at each certain CPE device 240, such as STBs 245 and a PC 246, and electrical communications with other certain CPE device 240, such as a TV 244 over COAX 233 and a telephone 241 and a BHR 247 over TP 234.

Referring generally to FIGS. 2-2-2-4, extending optical communications over optical fiber 232 to CPE devices 240 (e.g., ATA 243, STB 245, PC 246 and BHR 247 of FIG. 2-2; STB 245 and PC 246 of FIG. 2-3; and STBs 245 and PCs 246 of FIG. 2-4) allows them to terminate only optical signals supporting services for that CPE device 240. For example, the ATA 243 of FIG. 2C terminates voice channels, which may be carried on 1490 nm and 1310 nm wavelength signals, from the PON 217, and may use a digital signal processor (DSP) for processing of Session Initiation Protocol (SIP) services. Similarly, STB 245 processes IP TV channels from the PON 217 in the customer premises of FIGS. 2-2-2-4.

Consequently, this reduces the number of components in the network. For example, the STB 245 can communicate directly with an OLT (e.g., OLT 215 of FIG. 2), rather than having to communicate with a BHR and an ONT in other traditional networks (not shown). Further, adding CPE-ONTs 230′ to the CPE devices 240 improves the economics for optical components, such as transceivers, fiber and GPON products. Moreover, each CPE device has access to the entire GPON bandwidth. This increases performance due to fewer bottlenecks that may be experienced at either the ONT 230 in customer premises 235a or a BHR carrying communications in an electrical domain (i.e., the 10/100 BaseT interfaces of the BHR and the 100/1000BaseT or 1000BaseT interfaces of an ONT). Separate 2.4 Gbps connections in a customer premises makes each CPE device 240 capable of ultra high throughput and can enable even more applications in the market.

FIG. 3A is a diagram illustrating a PON 317 with a logical subgroup 355 representing logical connections between an OLT 315 and all ONTs 330 that are part of the same physical PON interface from the OLT 315. However, as described below with reference to FIGS. 3B-3C, extending optical communications over optical fiber enables the creation of logical subgroups of CPE devices defined based on relationships of physical layer properties of communications in the communications network.

FIG. 3B is a diagram of an example embodiment of the present invention illustrating a customer premises 335 (e.g., customer premises 235b of FIG. 2B) with the addition of logical subgroups. Each CPE-ONT 330′ at the customer premises 335 may be preconfigured before installation by the service provider. In this example network there are four logical subgroups: (1) an OLT-level logical subgroup 355; (2) a customer premises-level logical subgroup 360; (3) a device-level logical subgroup 365; and (4) a user-level logical subgroup 370.

The OLT-level logical subgroup 355 includes all ONTs 330 (not shown), ONT-GWs 331, and CPE-ONTs 330′ that may be supported by a particular OLT 315, including the ONT-GW 331, ATA 343, STBs 345, PC 346 and BHR 347. The customer premises-level logical subgroup 360 includes all CPE-ONTs 330′ at the customer premises 335, including the ATA 343, STBs 345, PC 346 and BHR 347. The device-level logical subgroup 365 includes, for example, all STBs 345 at the customer premises 335. The user-level logical subgroup 370 includes all CPE devices that may be used by a particular type of user, including the ATA 343, STB 345 and PC 346.

FIG. 3C is a diagram illustrating a further extension of the logical subgroup concept in which a service provider may assign multiple CPE-ONTs 330′ to a group within a customer premises (e.g., apartment building) 335. Under this model, there can be multiple groupings which may be associated with other higher-level logical groups. For example, a customer sub-premises 335′ (e.g., an apartment within the apartment building 335a) may have a logical subgroup 375 associated with it, which further may be associated with a logical subgroup 360 for the customer premises 335a. Moreover, various customer premises on a street, such as the apartment building 335a and a house 335b, may be associated with a street-level logical subgroup 380. Thus, for example, a CPE-ONT 330′ in a customer sub-premises 335′ may be associated with several logical subgroups, including the customer sub-premises-level logical subgroup 375, the customer premises-level logical subgroup 360, and the street-level logical subgroup 380.

Logical subgroups may be defined according to network interface type; service type; fault, configuration, accounting, performance, security (FCAPS); performance and technology (e.g., GPON, Ethernet Passive Optical Network (EPON)); accounting parameters; bandwidth and data management parameters; geographical parameters of network nodes in the communications network, such as building, apartment, condominium, home, street, neighborhood and town; service (e.g., voice, data, video); properties of users of network elements in the communications network, such as renters, lessees, owners, adults and children; organizations, such as universities or corporations; or physical characteristics of the network, such as a physical fiber split on the PON 317 (e.g., at OSC 325). CPE devices may be defined as part of a logical subgroup according to a serial number (SN) or registration identification number (RegID) associated with the CPE device 340. Further, data defining logical subgroups may be stored on a network element of the communications network, such as the OLT 315 or an EMS 320. Moreover, CPE devices 340 may be grouped in multiple logical subgroups. The multiple groupings may be defined according to the same relationship type, such that the logical subgroups are nested, or different relationship types. Further, logical subgroups may span multiple ONTs 330, ONT-GWs 331, OLTs 315 and PONs 317.

Further, logical subgroups may be defined at various times and in numerous manners. For example, network elements may be defined as part of a logical subgroup during pre-provisioning of the network element, during installation of the network element by a technician, after manufacture but before deployment of the network element, and at or after a time of purchase of the network element. The technician may use a local craft interface, dual-tone multi-frequency (DTMF) interface, network element interface, or wireless device interface.

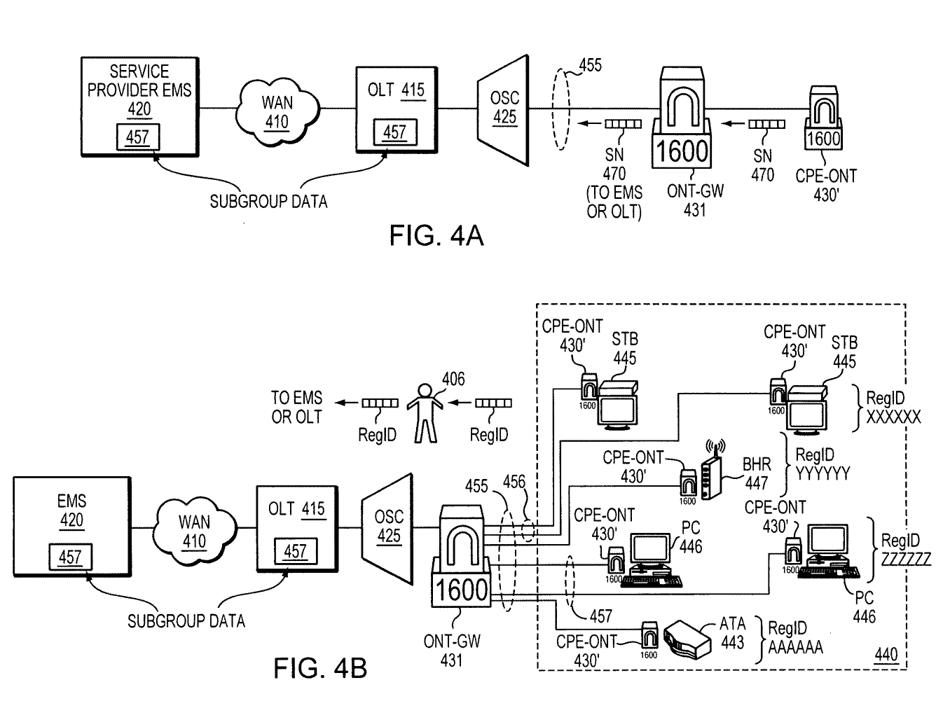

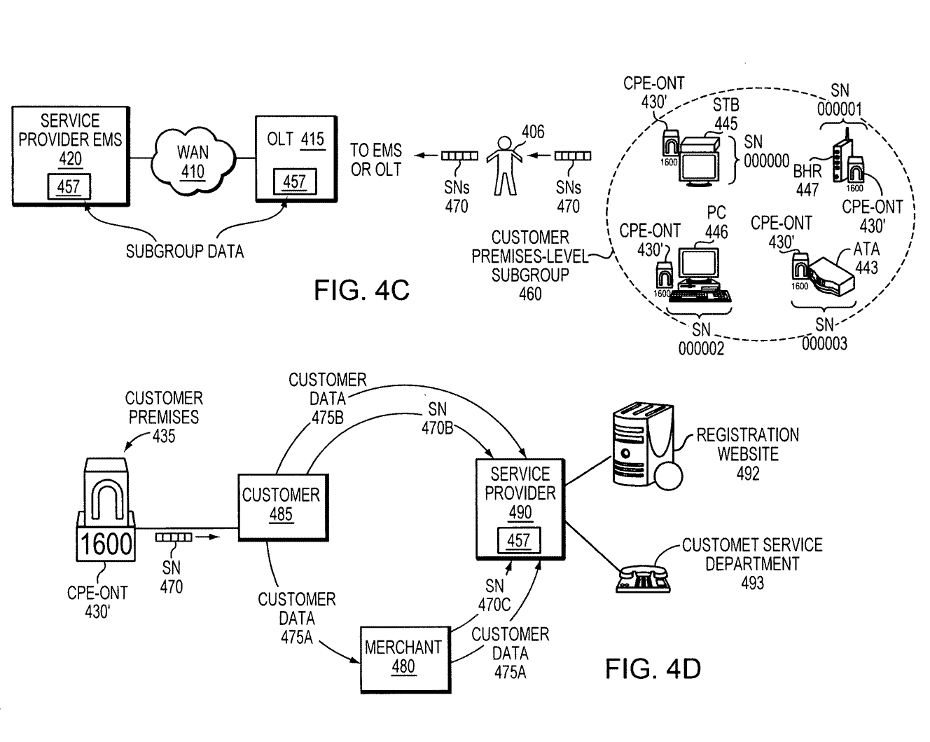

FIGS. 4A-4D are diagrams illustrating the flow of data in various methods by which parties may configure ONT-GWs and CPE-ONTs (e.g., ONT-GW 331 and CPE-ONTs 330′ of FIGS. 3B-3D) to a subgroup.

FIG. 4A illustrates a method by which a service provider, via its EMS 420, may establish a subgroup 455 by a Serial Number (SN) 470 of a CPE-ONT 430′ to be ranged during pre-provisioning. In this manner, the service provider may store subgroup data 457 (e.g., SNs 470 and corresponding subgroup 455 information) at the OLT 415 or EMS 420 to associate a CPE-ONT 430′ having a specific SN 470 with the specific subgroup 455.

FIG. 4B illustrates a method by which a technician 406, during installation of CPE-ONTs 430′, may enter a Registration ID (RegID) value corresponding to one or multiple subgroups. In this example embodiment, the subgroups are associated with each type of device with a CPE-ONT 430′ that a user may have in a customer premises. For example, STBs 445 may have a RegID of XXXXXX, BHRs 447 may have a RegID of YYYYYY, PCs 446 may have a RegID of ZZZZZZ, and ATAs 443 may have a RegID of AAAAAA. An OLT 415 or EMS 420 storing subgroup data 457 may know that the particular device being registered is the one specified by the RegID entered by a technician and perform specific actions, such as update its database 457 of CPE-ONTs 430′ associated with the subgroup 455. For example, the OLT 415 or EMS 420 associates, based on Reg ID values, all STBs 445 with a specific device-level subgroup 456 and all PCs 446 with another specific device-level subgroup 457. Further, all Reg IDs of all CPE devices 440 at the customer premises are associated with a customer premises-level subgroup 455.

FIG. 4C illustrates a method by which a technician 406 may associate a CPE-ONT 430′, after its manufacture but prior to its deployment, with a particular customer premises-level subgroup 460 in an association database 457. In this example embodiment, Serial Numbers (SNs) 470 of CPE-ONTs 430′ to be included in the customer premises-level subgroup 455, which may be listed on a service order, may be entered into the database 457 by the technician 406 before deployment to the customer premises 435. For example, an STB 445 may have a SN 470 of 000000, a BHR 447 may have a SN 470 of 000001, a PC 446 may have a SN 470 of 000002, and an ATA 443 may have a SN 470 of 000003. This associated list 457 may be maintained in the EMS 420 or the OLT 415 so that the OLT 415 is aware of the customer premises-level subgroup 455.

Further, the technician 406 may have a device that is capable of transmitting CPE-ONT SNs 470 associated with the customer premises-level subgroup 455. The technician may use a local craft interface, wireless interface (such as Wi-Fi or Bluetooth), DTMF interface, or via the CPE-ONT 430′ itself, such as a STB with ONT function integrated within it. The technician also may have a wireless (such as Wi-Fi or cellular) device that is capable of scanning a barcode or other identifier or accepting manual entry of the RegID or SN for each CPE-ONT 430′ that belongs to a specific subgroup. The data may be sent to the OLT 415 or EMS 420 via flow-through provisioning or a similar method.

FIG. 4D illustrates a method by which subgroup data may be communicated during purchase of a CPE-ONT 430′ from a merchant 480. When a customer 485 purchases a CPE-ONT 430′ for self installation from a retailer or other merchant 480, the retailer 480 may have an agreement with a service provider 490 to access the service provider to send the SN 470 of the CPE-ONT 430′ purchased by the customer 485 so that the service provider 490 may enter it in a database 457. Thus, the customer 485 (e.g., the service provider's subscriber) simply may bring the purchased product 430′ to the customer premises 435 and connect it directly to a fiber interface (not shown) without being required to call the service provider 490 or provide the service provider 490 with information by any other means. In this example embodiment, the merchant 480 may retrieve customer data 475a from a customer 485. The merchant then may transmit the customer data 475c with the SN 470c of the CPE-ONT 430′ purchased by the customer 485 to a service provider 490, which then may use the information 470c, 475c to create a subgroup. The customer 485 then may bring the CPE-ONT 430′ to the customer premises 435 for self-installation.

Alternatively, after purchase by a customer 485 for self-installation, the customer 485 may transmit a CPE-ONT 430′ SN 470b to a service provider 490, entering the SN 470b with customer data 475b at a registration website 492 operated by the service provider 490 or by calling a customer service department 493 operated by the service provider 490 to report the SN 470b to be associated with a subgroup.

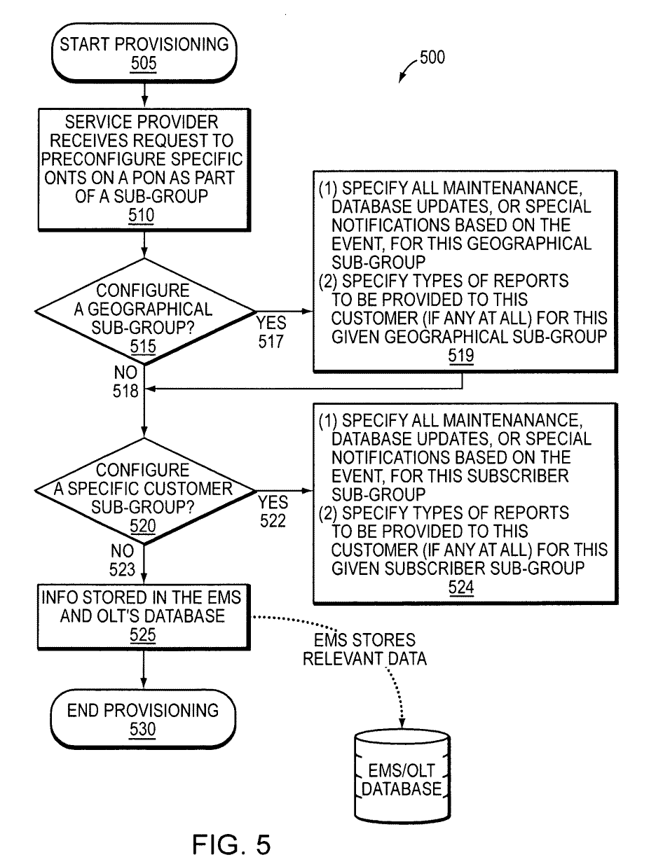

FIG. 5 is a flow diagram 500 illustrating a method for configuring ONTs and CPE-ONTs, generally referred to as ONTs, as part of a logical subgroup. In this example embodiment, the customer and the service provider know if all devices in the customer premises are CPE-ONT-based (i.e., fiber) or legacy (i.e., electrical) interfaces, and what type of configuration the customer wants. After the start 505 of the provisioning process a service provider receives a request to pre-configure specific ONTs on a PON as part of a subgroup (510).

Next, it is determined (515) whether the subgroup is based on geography. If the subgroup is based on geography (517), the method (1) specifies maintenance, database updates or special notifications based on the event for this geographical subgroup; and (2) specifies types of reports to be provided to the customer, if any, for the given geographical subgroup (519). The user configures a specific range of ONTs with an identifier, such as street, name, address, building floor, company name, city, complex/subdivision name, school name, etc.

Then, even if the subgroup is not based on geography (518), the flow diagram 500 determines whether the subgroup is based on a specific customer (520). If the subgroup is based on customer (522), the method (1) specifies maintenance, database updates or special notifications based on the event for this subscriber subgroup; and (2) specifies types of reports to be provided to the customer, if any, for the given subscriber subgroup (524). The user configures a specific range of ONTs with an identifier, such as BHR-ONT, STB-ONT, PC-ONT, ATA-ONT, etc.

Then, even if the subgroup is not based on a customer (523), information is stored (525) in the EMS/OLT database. Then the provisioning process ends (530). Note that, for subgroups based on either geography or customer, the ranged ONTs in the logical subgroup do not have to be part of the same physical ONT interface. Management of such subgroups can be performed across OLTs, across multiple platforms, as long as all the information in the EMS/OLT database is accessible or synchronously managed across the system, in this example embodiment.

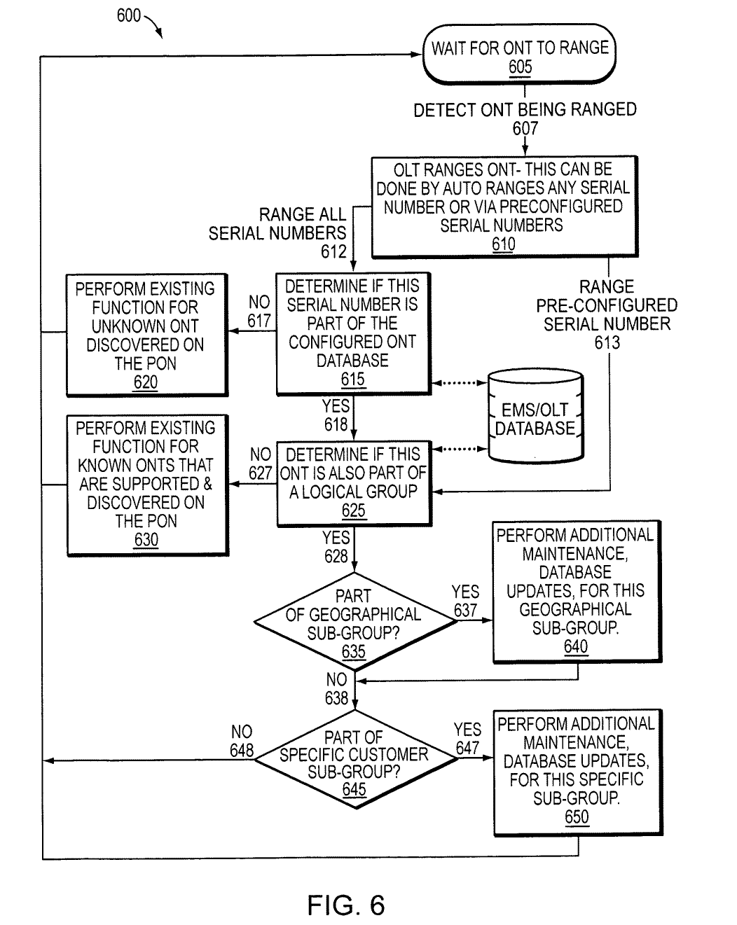

FIG. 6 is a flow diagram 600 illustrating actions performed by an OLT during the ranging/discovery process for ONTs and CPE-ONTs, generally referred to as ONTs. First, the OLT waits 605 for an ONT to begin the ranging process. Once such an ONT is detected (607), the OLT ranges the ONT (610). This can be performed by automatically ranging all SNs or via preconfigured SNs.

If the OLT ranges all SNs (612), the OLT determines (615) if the SN is part of the configured ONT database 619. If it is not (617) part of the database 619, the OLT performs legacy functions for unknown ONTs discovered on the PON (620). In this legacy behavior, the ONT may unrange or support this ONT, depending on the implementation. The OLT then returns to wait 605 for an ONT to range.

If the SN is (618) part of the ONT database, or if preconfigured SNs are ranged (613), the OLT determines if the ONT is also part of a logical group (625). If the ONT is not part of a logical group (627), the OLT performs legacy functions for known ONTs that are supported and discovered on the PON (630). The OLT then returns to wait 605 for an ONT to range.

If the ONT is part of a logical group (628), the OLT determines if the ONT is part of a geographical subgroup (635). If the ONT is part of a geographical subgroup (637), the OLT performs additional maintenance and database updates for the particular geographical subgroup (640).

After maintenance (640) or if the ONT is not part of a geographical subgroup (638), the OLT determines if the ONT is part of a specific customer subgroup (645). If the ONT is part of a customer subgroup (647), the OLT performs additional maintenance and database updates for the particular customer subgroup (650). The OLT then returns to wait 605 for an ONT to range. The customer-specific subgroup may be within a PON, it may have different characteristics, may employ special software loads or special ONT parameters/attributes for ONTs for that customer, and may also employ special alarm handling for ONTs for that customer. The subgroup may collect special statistics and generate special reports for a specific group of ONTs for the customer. If the ONT is not part of a customer subgroup (648), the OLT returns to wait 605 for an ONT to range. The logical subgroups, both based on geography and customer, do not have to be part of the same physical PON interface. Management of such subgroups can be performed across OLTs and across multiple platforms, as long as all the information in the EMS/OLT database is accessible or synchronously managed across the system

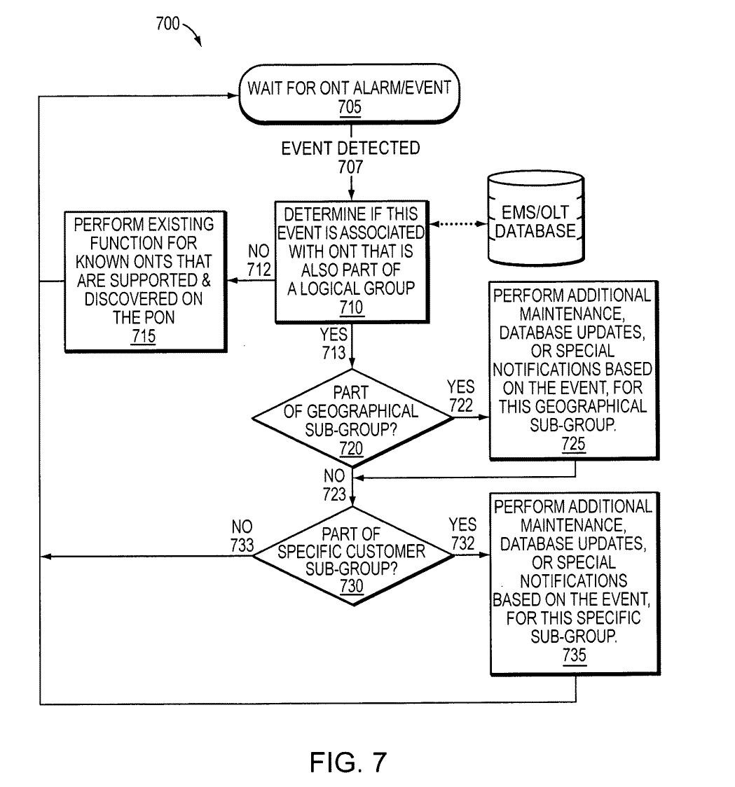

FIG. 7 is a flow diagram 700 illustrating an example method by which an OLT of the system behaves when there are notifications/events detected either locally or remotely for a given ONT or CPE-ONT, generally referred to as ONTs, that may or may not be part of a logical group. First, the OLT waits 705 for an alarm/event from the ONT. This can be an event that is triggered upon receiving a notification from the ONT or by a locally triggered event such as a timer or some other location detection (e.g., loss-of-signal).

When an event is detected (707), the OLT determines (710) if the event is associated with an ONT that is part of a logical group by checking the EMS/OLT database 711. If the ONT is not associated with a logical group (712), at step the OLT performs existing legacy functions for known ONTs that are supported and discovered on the PON (715).

If the ONT is associated with a logical group (713), the OLT determines if the ONT is part of a geographical subgroup (720). If the ONT is part of a geographical subgroup (722), the OLT performs additional maintenance and database updates, or special notifications based on the event for the particular geographical subgroup (725). The geographical subgroup may be within a PON, but may have different characteristics, may require special software loads or special ONT parameters/attributes for ONTs in that location.

It also may employ special alarm handling for ONTs from that location. The subgroup may collect special statistics and generate special reports for a specific group of ONTs in the location.

If the ONT is not part of a geographical subgroup (723), the OLT determines if the ONT is part of a specific customer subgroup (730). If the ONT is part of a customer subgroup (732), the OLT performs additional maintenance and database updates, or special notification based on the event for the particular customer subgroup (735). The OLT then returns to wait 705 for an ONT to range. The customer-specific subgroup may be within a PON, it may have different characteristics, may require special software loads or special ONT parameters/attributes for ONTs for that customer, and may also require special alarm handling for ONTs for that customer. The subgroup may collect special statistics and generate special reports for a specific group of ONTs for the customer. If the ONT is not part of a customer subgroup, the OLT returns to waiting 705 for an ONT to range. The logical subgroups, both based on geography and customer, do not have to be part of the same physical PON interface. Management of such subgroups can be performed across OLTs and across multiple platforms, as long as all the information in the EMS/OLT database is accessible or synchronously managed across the system.

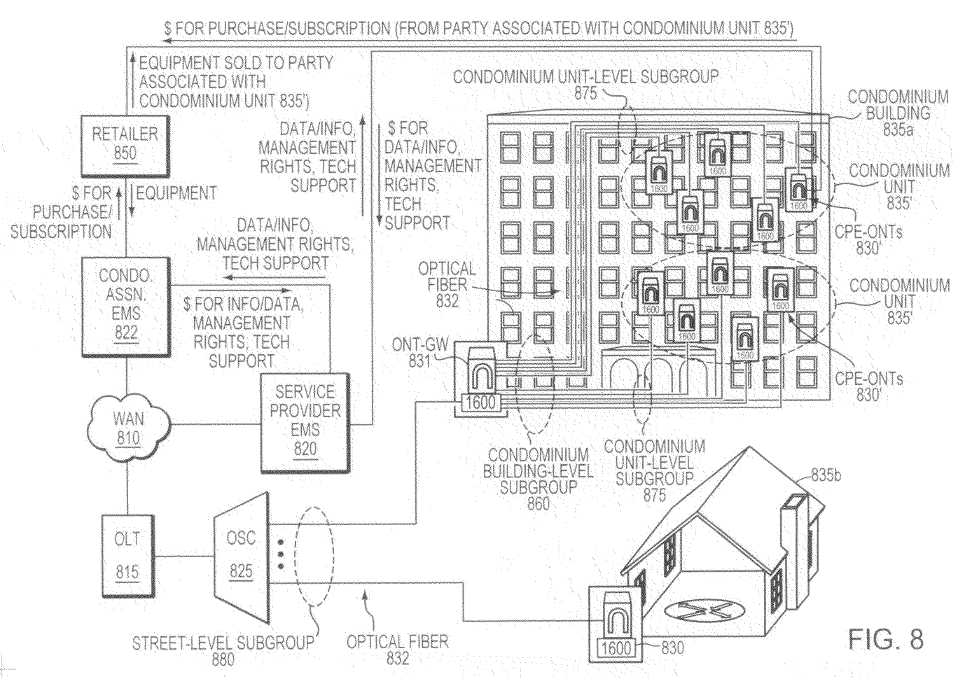

FIG. 8 is a diagram illustrating the flow of information and payment for that information between a builder, condominium association, homeowners association or similar organization having an organization EMS 822 and a service provider having a service provider EMS 820. The fee may be for up-to-date information about the quality of a logical subgroup.

In this example embodiment, the service provider, via its EMS 820, gathers data regarding alarms, statistics, updates, software information and other data for the particular logical geographic subgroup, such as a condominium building 835a customer premises-level subgroup 860. This service may include periodic reports that are sent from the service provider 820 to the organization (e.g., condominium association) 822 or, alternatively, the organization 822 may have on-demand or real-time access to the real-time status, statistics and configuration information of the customer premises-level logical subgroup 860. This information may allow the organization 822 to better manage the CPE-ONTs 830′ allocated to them.

Further, a builder, condominium association or similar organization, via its EMS 822, may manage a logical subgroup, such as a condominium building customer-premises-level subgroup 860, under a pre-determined arrangement with a service provider 820, so that the service provider 820 allocates either a PON 817 or a pre-determined number of CPE-ONTs 830′ on the PON 817 to a particular condominium building 835a or other customer premises or sub-premises, such as a condominium unit 835′. These CPE-ONTs/PONs then may be self-managed by the organization, for example, via its EMS 822 over the Internet or other network 810 to the service-provider's EMS 820. This access may be limited to access to manage the pre-determined devices that were in the original agreement or as later amended (e.g., CPE-ONTs 830′ installed in the condominium building 835a). In this scenario, the organization 822 configures and manages the CPE-ONTs 830′ in condominium unit-level subgroups 875 as individual customers in the organization move in and out from each condominium unit customer sub-premises 835′. Therefore, customers pay the organization 822 for access to the PON, which may be a direct fee or included in an existing fee such as a condominium association fee, but the organization 822, in turn, manages this pre-determined number of CPE-ONTs 830′. Further, the individual customers either may call the organization 822 or, alternatively, if such support is included in the agreement between the organization 822 and the service provider 820, the service provider 820 directly to report technical problems.

Here, a condominium building 835a has a plurality of individual condominium unit customer premises 835′, each having a plurality of CPE-ONTs 830′ organized by logical subgroups 875. Further, all CPE-ONTs 830′ in the condominium building 835a are associated with a condominium building-level subgroup 860. Moreover, all CPE-ONTs 830′ supported by the OLT 815, including at the condominium building 835a and a house 835b, are associated with, for example, a street-level logical subgroup 880.

For example, the OLT interface does not need to be located in the central office, but can alternatively be located in the same customer premises as a separate UNI interface within an existing ONT, thereby resulting in a cascaded PON. Further, this OLT may be considered UNI-side GMII interface that is integrated within a CPE-ONT device. For example, this could be a second-level PON interface or, alternatively, named a cascaded PON network where the first level controls all ONTs on a PON and the second level controls all ONTs within a customer premises. Moreover, a PON interface can support either configuring ONTs as logical devices within a customer premises or in combination with ONTs that are the only interface within the customer premise.

Further, a customer, or the condominium association or other organization, may purchase CPE-ONTs 830′ from a retailer 850. The customer may then bring the CPE-ONT 830′ to the customer premises, such as a condominium unit 835′, and perform a self-installation in which the CPE-ONT 830′ is ranged by the OLT 815. In purchasing the CPE-ONT 830′ from the retailer 850, the customer pays a fee

The service provider, via its EMS 820, may store information regarding a logical subgroup 860, 875 and may manage the logical subgroup according to management instructions received from a party associated with the logical subgroup, through a management interface accessible by the party. The service provider 820 may then collect a fee for the management rights, and for the support of the logical subgroup, from the party, which may be an organization associated with the logical subgroup, a representative of the organization acting on behalf of the organization, or a member of the organization. The organization associated with the logical subgroup is a builder, condominium association 822 or homeowners association.

The service provider 820 may monitor a quality of the logical subgroup 860, 875 and provide information regarding the logical subgroup 860, 875 and the quality of the logical subgroup 860, 875 to the party (e.g., condominium association 822) in periodic reports, on-demand or in real-time. Parameters to be monitored may include latency, packet size, packet rates, jitter, packet header information, or information discovered from the downstream nodes such as alarms, performance monitoring, statistics, updates, and software version. Further, the service provider 820 may provider technical support to the party and collect a fee for the technical support.

The service provider 820 may provide network elements to a retailer 850 for subscription to the logical subgroup 860, 875. The retailer 850 may then collect information regarding network elements (e.g., CPE-ONTs 830′) sold and parties (e.g., condominium association 820 and owners of condominium units 835′) to whom the network elements are sold. The service provider 820 may then provide the parties access to the management interface to manage the network elements, and may subscribe the purchase network elements to the logical subgroup.

Managing the logical subgroup may include configuring and managing the network elements 830′ in response to a change in state of network elements in the logical subgroup 860, 875. The change in state may be a change in a subscription status of a network element associated with a member of the organization, the method further comprising collecting a fee from the member for changing the subscription status of the network element in the logical subgroup associated with the organization. Further, management of the logical subgroup by the organization is limited to predetermined devices.

Information defining the logical subgroup includes network interface type; service type; fault, configuration, accounting, performance, security (FCAPS); performance, technology; geographical parameters of network nodes in the communications network; service; properties of users of network elements in the communications network; organizations; and physical characteristics of the network.

While this invention has been particularly shown and described with references to example embodiments thereof, it will be understood by those skilled in the art that various changes in form and details may be made therein without departing from the scope of the invention encompassed by the appended claims.

Various features of the present invention can be realized or implemented in hardware, software, or a combination of hardware and software. By way of example only, some aspects of the subject matter described herein may be implemented in computer programs executing on programmable computers or otherwise with the assistance of microprocessor functionalities. In general, at least some computer programs may be implemented in a high level procedural or object-oriented programming language to communicate with a computer system. Furthermore, some programs may be stored on a storage medium, such as for example read-only-memory (ROM) readable by a general or special purpose programmable computer, for configuring and operating the computer or machine when the storage medium is read by the computer or machine to perform the provided functionality.

What is claimed is:

1. A method of managing network nodes in a communications network, the method comprising:
performing a first ranging;
performing a second ranging;
allocating upstream timeslots to downstream nodes based on timeslots assigned by an upstream node in the communications network;
monitoring the downstream nodes for a change of state of the downstream nodes; and
reallocating upstream timeslots of the downstream nodes, based on results of at least one of the first ranging and the second ranging and a change of state of downstream nodes configured to communicate in an upstream direction, to manage the network nodes in the communications network.

2. The method of claim 1 wherein the change of state of the downstream nodes is a change of nodes or change of upstream communications.

3. The method of claim 1 wherein upstream timeslots of the downstream nodes are reallocated based on a number of downstream nodes.

4. The method of claim 1 wherein upstream timeslots of the downstream nodes are reallocated based on characteristics of communications of the downstream nodes.

5. The method of claim 4 wherein characteristics include one or more of: latency, packet size, packet rates, jitter, packet header information, or information discovered from the downstream nodes.

6. The method of claim 1 wherein allocating upstream timeslots to downstream nodes is further based on presence of other communications services supporting upstream communications to the upstream node.

7. The method of claim 1 wherein allocating and reallocating upstream timeslots to downstream nodes is further based on priority of services supporting upstream communications to the upstream node.

8. The method of claim 1 further comprising renegotiating with the upstream node to change the upstream timeslots configured to communicate in the upstream direction allocated to the downstream nodes.

9. The method of claim 1 wherein allocating and reallocating upstream timeslots to downstream nodes is based on subgroups to which the downstream nodes are assigned.

10. The method of claim 1 wherein allocating and reallocating upstream timeslots to downstream nodes is based on modifying a grant map by the upstream node and further comprising adjusting the grant map based on a change of state of the downstream node for use in future reallocating of the upstream timeslots.

11. The method of claim 1 wherein reallocating upstream timeslots to downstream nodes is performed by the upstream node.

12. The method of claim 1 wherein reallocating upstream timeslots to downstream nodes is performed independent of the upstream node.

13. The method of claim 1 wherein the communications network is a point-to-multipoint network.

14. The method of claim 13 wherein the point-to-multipoint network is a Multimedia over Coax Alliance (MoCA) network.

15. The method of claim 13 wherein the point-to-multipoint network is a Passive Optical Network (PON), the upstream node is an Optical Line Terminal (OLT), and the downstream nodes are Customer Premises Equipment Optical Network Terminals (CPE-ONTs).

16. The method of claim 15 further comprising:
splitting and combining communications downstream of the upstream node and upstream of at least one of the downstream nodes; and
performing at least one of the allocating, monitoring and reallocating at an intermediate node downstream of the splitting and combining and upstream of at least one of the downstream nodes.

17. The method of claim 16 further comprising splitting and combining communications downstream of the intermediate node and upstream of at least one of the downstream nodes.

18. The method of claim 16 further comprising communicating with nodes in an electrical or wireless network other than the PON.

19. The method of claim 17 further comprising communicating with nodes in an electrical or wireless network other than the PON.

20. An apparatus for managing network nodes in a communications network, the apparatus comprising:
a ranging unit to conduct a first physical layer ranging with an upstream node and a second physical layer ranging with downstream nodes;
a monitoring unit to monitor the downstream nodes for a change of state of the downstream nodes;
an allocation unit to allocate upstream timeslots to downstream nodes based on timeslots assigned by the upstream node; and
a management unit to instruct the allocation unit to reallocate upstream timeslots of the downstream nodes based on results of the first physical layer ranging and the second physical layer ranging and a change of state of downstream nodes configured to communicate in an upstream direction.

21. The apparatus of claim 20 wherein the change of state of the downstream nodes is a change of nodes or change of upstream communications.

22. The apparatus of claim 20 wherein the allocation unit is further configured to reallocate upstream timeslots of the downstream nodes based on a number of downstream nodes.

23. The apparatus of claim 20 wherein the allocation unit is further configured to reallocate upstream timeslots of the downstream nodes based on characteristics of communications of the downstream nodes.

24. The apparatus of claim 23 wherein characteristics include one or more of: latency, packet size, packet rates, jitter, packet header information, or information discovered from the downstream nodes.

25. The apparatus of claim 20 wherein the allocation unit is further configured to allocate upstream timeslots to downstream nodes further based on presence of other communications services supporting upstream communications to the upstream node.

26. The apparatus of claim 20 wherein the allocation unit is further configured to allocate and reallocate upstream timeslots to downstream nodes further based on priority of services supporting upstream communications to the upstream node.

27. The apparatus of claim 20 wherein the allocation unit is further configured to renegotiate with the upstream node to change the upstream timeslots configured to communicate in the upstream direction allocated to the downstream nodes.

28. The apparatus of claim 20 wherein the allocation unit is further configured to allocate and reallocate upstream timeslots to downstream nodes based on subgroups to which the downstream nodes are assigned.

29. The apparatus of claim 20 wherein the allocation unit is further configured to allocate and reallocate upstream timeslots to downstream nodes based on modifying a grant map by the upstream node and adjust the grant map based on a change of state of the downstream node for use in future reallocating of the upstream timeslots.

30. The apparatus of claim 20 wherein the allocation unit is the upstream node.

31. The apparatus of claim 20 wherein the allocation unit is a node intermediate of the upstream node and the downstream nodes.

32. The apparatus of claim 20 wherein the communications network is a point-to-multipoint network.

33. The apparatus of claim 32 wherein the point-to-multipoint network is a Multimedia over Coax Alliance (MOCA) network.

34. The apparatus of claim 32 wherein the point-to-multipoint network is a Passive Optical Network (PON), the upstream node is an Optical Line Terminal (OLT), and the downstream nodes are Customer Premises Equipment Optical Network Terminals (CPE-ONTs).

35. The apparatus of claim 34 wherein the PON includes a first Optical Splitter/Combiner (OSC) downstream of the OLT and upstream of the CPE-ONTs, and an ONT Gateway (ONT-GW) downstream of the OSC and upstream of at least one of the CPE-ONTs, the ONT-GW including the allocation unit, the monitoring unit, and the management unit.

36. The apparatus of claim 35 wherein the PON includes a second OSC downstream of the ONT-GW and upstream of at least one of the CPE-ONTs.

37. The apparatus of claim 35 wherein the ONT-GW further includes components to communicate with nodes in an electrical or wireless network other than the PON.

38. The apparatus of claim 36 wherein the ONT-GW further includes components to communicate with nodes in an electrical or wireless network other than the PON.

39. A computer program product comprising a computer readable medium having computer readable code stored thereon, which, when executed by a processor, causes the processor to:
allocate upstream timeslots to downstream nodes based on timeslots assigned by an upstream node in the communications network;
monitor the downstream nodes for a change of state of the downstream nodes; and
reallocate upstream timeslots of the downstream nodes based on results of the first physical layer ranging and the second physical layer ranging and a change of state of downstream nodes configured to communicate in an upstream direction.

40. A method of supporting a logical subgroup of network elements in a network, the method comprising:
storing information defining the logical subgroup;
managing the logical subgroup according to management instructions received from a party associated with the logical subgroup through a management interface accessible by the party; and
collecting a fee for the support of the logical subgroup.

41. The method of claim 40 wherein the party is one or more of an organization associated with the logical subgroup, a representative of the organization acting on behalf of the organization, or a member of the organization.

42. The method of claim 40 wherein the organization associated with the logical subgroup is a builder, condominium association or homeowners association.

43. The method of claim 40 further comprising:
monitoring a quality of the logical subgroup; and
providing information regarding the logical subgroup and the quality of the logical subgroup to the party in periodic reports, on-demand or in real-time.

44. The method of claim 43 wherein monitoring the quality of the logical subgroup further comprises monitoring latency, packet size, packet rates, jitter, packet header information, or information discovered from the downstream nodes such as alarms, performance monitoring, statistics, updates, and software version.

45. The method of claim 40 further comprising:
providing technical support to the party; and
collecting a fee for the technical support.

46. The method of claim 40 further comprising:
providing network elements to a retailer for subscription to the logical subgroup;
collecting information regarding network elements sold and parties to whom the network elements are sold;
providing the parties access to the management interface to manage the network elements; and
subscribing the network elements sold to the logical subgroup associated with the party.

47. The method of claim 40 wherein managing the logical subgroup further comprises configuring and managing the network elements in response to a change in state of network elements in the logical subgroup.

48. The method of claim 47 wherein the change in state of network elements is a change in a subscription status of a network element associated with a member of the organization, the method further comprising collecting a fee from the member for changing the subscription status of the network element in the logical subgroup associated with the organization.

49. The method of claim 40 wherein management of the logical subgroup by the organization is limited to predetermined devices.

50. The method of claim 40 wherein information defining the logical subgroup includes network interface type; service type; fault, configuration, accounting, performance, security (FCAPS); performance, technology; geographical parameters of network nodes in the communications network; service; properties of users of network elements in the communications network; organizations; and physical characteristics of the network.
